(19) United States
(12) Patent Application Publication
(10) Pub. No.: US 2007/0227720 A1
(43) Pub. Date: Oct. 4, 2007

(54) A METHOD AND A STRUCTURE FOR UNIFORMLY DISTRIBUTING HEAT

(75) Inventor: Hsin-Ning Kuan, Sinjhuang City (TW)

Correspondence Address: PAI PATENT & TRADEMARK LAW FIRM, 1001 FOURTH AVENUE, SUITE 3200, SEATTLE, WA, 98154, US

(73) Assignee: THERMOKING TECHNOLOGY INTERNATIONAL CO., Sinjhuang City, Taipei County (TW)

(21) Appl. No.: 11/308,528

(22) Filed: Apr. 3, 2006

(51) Int. Cl. F28D 15/00; G05D 23/00

(52) U.S. Cl. 165/287; 165/171; 165/104.21

(57) ABSTRACT

A method and a structure for uniformly distributing heat is disclosed, said structure comprising a heat plate having a heat conductor attached to the bottom of said heat plate. When said heat conductor is connected to a heat source, said heat source quickly transfers heat all over said heat conductor and said heat conductor conducts the heat to the heat plate, turning said heat plate into a heating board for use in cold places and for purposes such as warming, heating, baking and drying, etc.

### BACKGROUND OF THE INVENTION

1. Field of the Invention

The present invention relates to a method and a structure for uniformly distributing heat, and more particularly, to a method and a structure comprising a heat plate having a heating element disposed on the bottom of the heat plate to form a heating board for uniformly distributing heat in cold places and for purposes such as warming, baking and drying.

2. Description of the Prior Art

In order to increase the indoor temperature under cold weather, in the process of wallboard or floorboard construction, it is often to have hot-water pipes uniformly buried and distributed inside the floorboard and wallboard to form a loop. When hot water is poured into hot-water pipes, it will be guided along the path to evenly pass through floorboard or wallboard. Consequently, when the heat of hot water is transferred through the surfaces of hot-water pipes to the floorboard or wallboard, the floorboard or wallboard will be heated and the room temperature will rise. However, the traditional construction method has some disadvantages, such as:

1. The traditional construction method is time and labor consuming, and it requires lots of hot-water pipes, which increase the construction cost to make the traditional construction method less cost-effective.

2. If one hot-water pipe should crack, it is very difficult to repair and to maintain the pipe under the traditional construction method.

Therefore, the above-mentioned traditional construction method has several shortcomings to be overcome.

In view of the above-described deficiencies of the traditional construction method, after years of constant effort in research, the inventor of this invention has consequently developed and proposed a method and a structure for uniformly distributing heat in the present invention.

### SUMMARY OF THE INVENTION

It is an object of the present invention to provide a method and a structure which comprises a heat plate having a heat conductor placed at the bottom of the heat plate so that when the heat of a heat source is conducted through the heat conductor to the bottom of the heat plate, the heat plate is turned into a heating element for use in cold places and for purposes such as warming, heating, baking and drying, etc.

It is another object of the present invention to provide a method and a structure for uniformly distributing heat and for construction of floorboard, wallboard or ceiling board.

It is another object of the present invention to provide a method and a structure for controlling the heat conducted to the heat conductor, so the heat plate will not be so hot as to harm human body.

The present invention discloses a method and a structure for uniformly distributing heat, comprising a heat plate and a heat conductor, the heat plate having a plurality of recesses placed at the bottom thereof, with one connecting part on each side of the heat plate for heat plates to join together and to extend unlimitedly; the heat conductor connecting to slots at the bottom of the heat plate and a heat source as well, so as to let the heat source transfer heat to the heat conductor, turning said heat conductor into a heating element to conduct heat to the heat plate. Thus, heat transferred from the heat source through the heat conductor turns the heat plate into a heating board for use in cold places and for purposes such as warming, heating, baking and drying, etc.

These features and advantages of the present invention will be fully understood and appreciated from the following detailed description of the accompanying Drawings.

### BRIEF DESCRIPTION OF THE DRAWINGS

FIG. 1 illustrates an exploded view of the structure for uniformly distributing heat of the present invention;

FIG. 2 illustrates the assembled view of the structure for uniformly distributing heat of the present invention;

FIG. 3 illustrates how the heat plates of the present invention can be connected with one another;

FIGS. 4A and 4B illustrate how a decorative board can be attached to the heat plate in the present invention;

FIG. 5 illustrates a second embodiment of the structure for uniformly distributing heat of the present invention; and

FIG. 6 illustrates an operational view of the structure for uniformly distributing heat of the present invention.

### DETAILED DESCRIPTION OF THE PREFERRED EMBODIMENT

The present invention discloses a structure comprising a heat plate having a heat conductor attached to the bottom of the heat plate, one end of the heat conductor connecting to a heat source to let heat from the heat source to be conducted through the heat conductor, such as a heat pipe, to the heat plate to turn the heat plate into a heating board. The heat plate can be provided as a floorboard, wallboard or ceiling board for construction purposes to increase the indoor temperature under cold weather. Besides, two or more heat plates can join together and extend unlimitedly to facilitate the construction work.

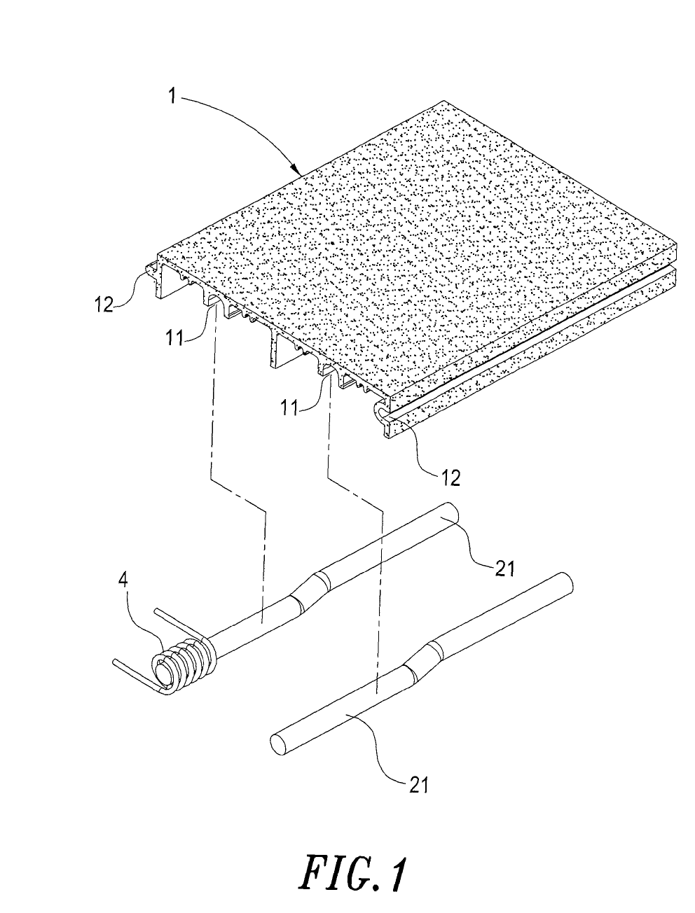

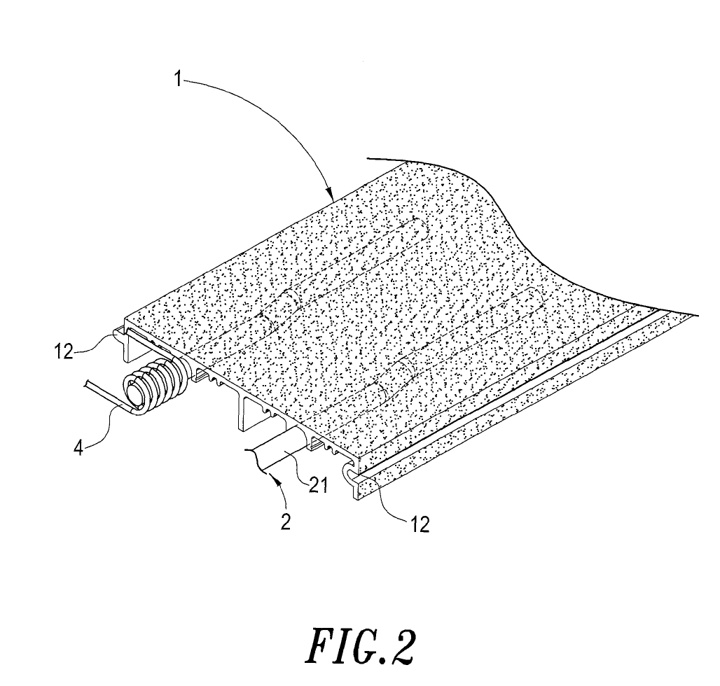

Please refer to FIGS. 1 to 4 for the method and the structure disclosed in the present invention. The structure comprises:

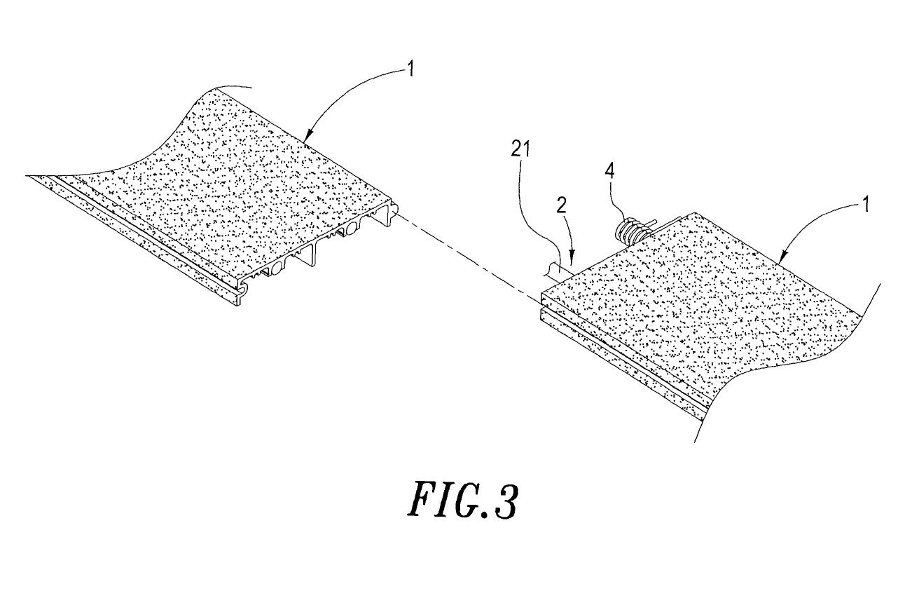

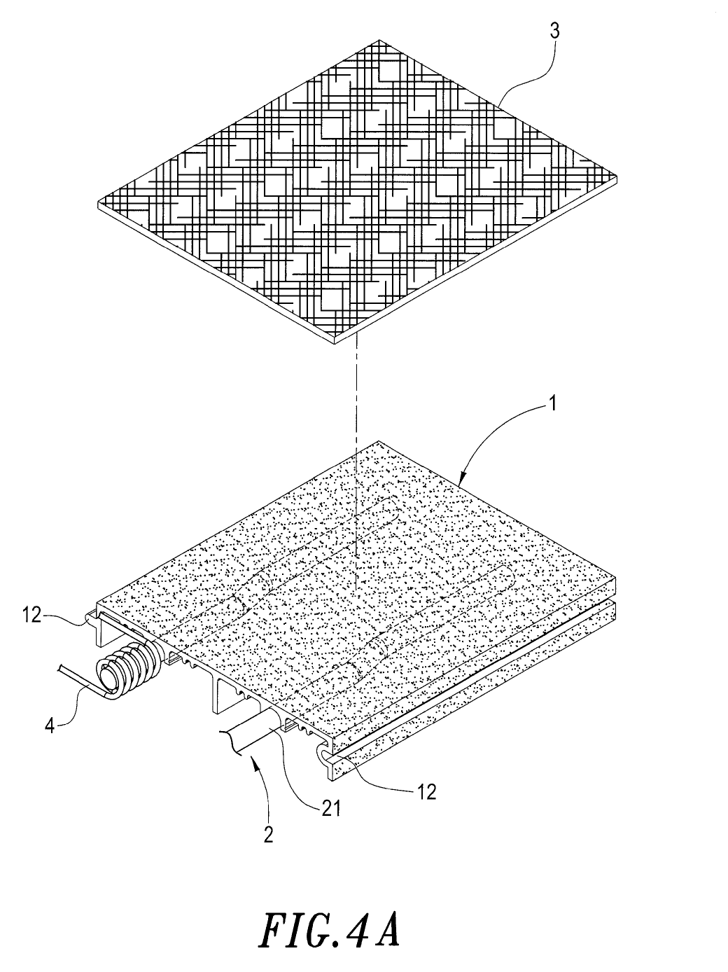

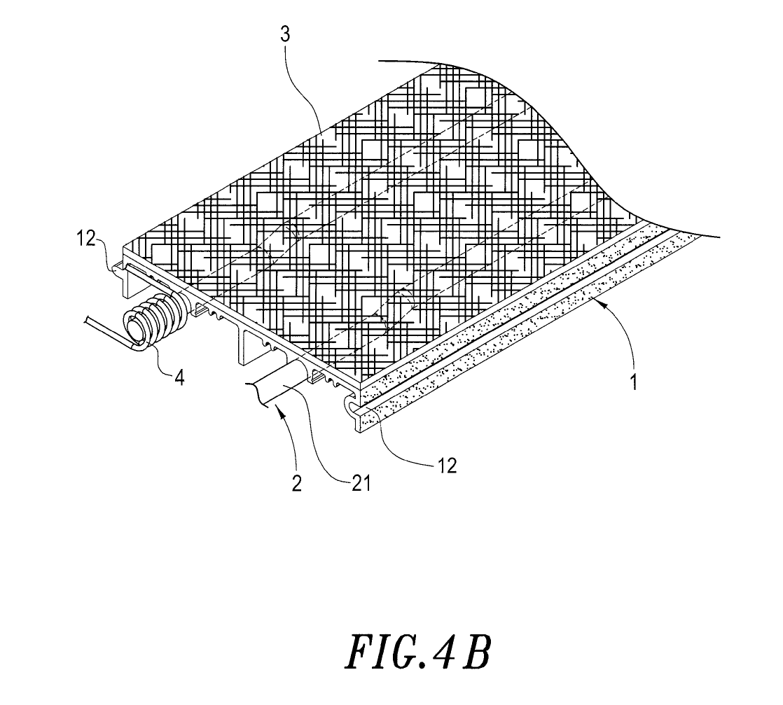

a heat plate 1 having a plurality of recesses 11 placed at the bottom of the heat plate 1 and one matching connecting part 12 on each side of the heat plate 1; the connecting part 12 can be a matching protruding edge or a slot for two heat plates to join together (as shown in FIG. 3). Besides, the heat plate 1 can be a highly heat-conductive metal board such as aluminum and copper boards. Furthermore, as illustrated in FIGS. 4A and 4B, in order to bring some aesthetic appearance to the heat plate 1, it is desirable to print various patterns or to attach a decorative board 3 on top of the heat plate 1, while the decorative board is made of wood, brick or PVC material.

a heat conductor 2, which can be a heat pipe 21 or an insulating heating wire with high heat conductivity, one end of the heat conductor 2 connecting to a heat source 4 which is wound around the end of the heat conductor 2. The heat source 4 can be a hot-water jacket or a heating wire to conduct heat to the heat conductor 2.

In the present invention, the heat conductor 2 is tightly coupled to the bottom of said heat plate 1 through the plurality of recesses 11 at the bottom of the heat plate 1. When the heat source 4 provides heat to the end of the heat conductor 2, the heat will be quickly conducted to the other end of the heat conductor 2 and to the heat plate 1, thus turning the heat plate 1 into a heating board. Besides, the heat source 4 can be connected to a temperature controller (not shown in figure) for controlling the temperature of the heat conductor 2 to prevent the heat distributed by the heat plate 1 from hurting human skin, and an over-temperature control switch (not shown in figure) for cutting off the connection to the heat source to keep the temperature from rising and to protect human body.

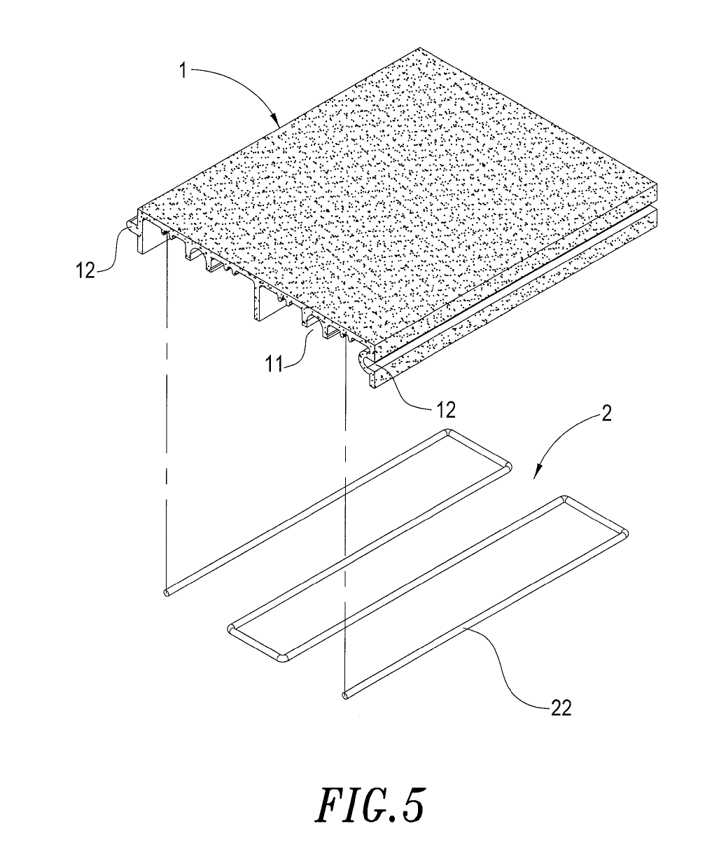

Please refer to FIG. 5 for another embodiment of the present invention. The heat conductor 2 can be a heating wire 22 to act as a heat source when connected to an electric power source, and the heat from the heat source can also be conducted to the heat plate 1 to turn the heat plate 1 into a heating board.

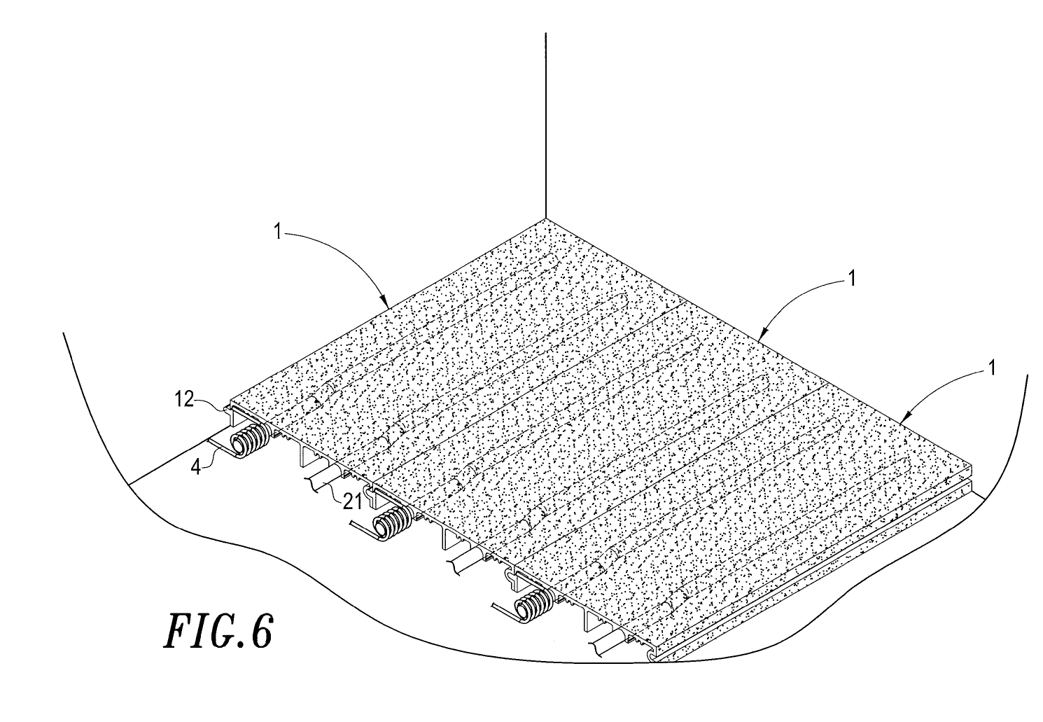

Please refer to FIG. 6 for an operational view of the present invention, wherein the heat plate 1 having the heat conductor 2 attached to its bottom can be used for purposes such as floorboard, wallboard or ceiling board. The connecting parts 12 on each side of the heat plate 1 can join together with another connecting part of another heat plate and thus extend unlimitedly, making it easy to assemble heat plates 1. It is efficient to warm up the interior space when using the heat plate as floorboard or wallboard and to melt the ice when using the heat plate as ceiling board.

The present invention provides a method and a structure for uniformly distributing heat, which, while compared with other traditional construction method, is advantageous in:

1. The present invention provides a heat plate having a heat conductor placed at the bottom of the heat plate. When the heat of a heat source is conducted through the heat conductor to the bottom of the heat plate, it will turn the heat plate into a heating element for use in cold places.

2. The present invention provides a structure for uniformly distributing heat which can be constructed as floorboard, wallboard or ceiling board.

3. The present invention provides a method and a structure for controlling the heat conducted to the heat conductor, so the heat plate will not be so hot as to harm human body.

Many changes and modifications in the above described embodiment of the invention can, of course, be carried out without departing from the scope thereof. Accordingly, to promote the progress in science and the useful arts, the invention is disclosed and its scope is intended to be limited only by the appended claims.

What is claimed is:

1. A method for uniformly distributing heat, said method comprises attaching a heat conductor to a bottom side of a heat plate, connecting an end of said heat conductor to a heat source to conduct heat from said heat source through the heat conductor to said heat plate to turn said heat plate into a heating board.

2. A structure for uniformly distributing heat, comprising:
a heat plate having a plurality of recesses placed at a bottom side thereof and one matching connecting part on each side of said heat plate; and
a heat conductor which is highly heat-conductive, said heat conductor having one end connected to a heat source;
wherein said heat conductor is tightly coupled to said bottom of said heat plate through said plurality of recesses at said bottom side of said heat plate for heat to be transferred from said heat source to said heat plate through said heat conductor to turn said heat plate into a heating board.

3. The structure of claim 2, wherein said matching connecting parts of said heat plate are a protruding edge and a matching slot for two or more heat plates to join together.

4. The structure of claim 2, wherein said heat plate is aluminum board or copper board.

5. The structure of claim 2, wherein a top side of said heat plate is printed with one or more patterns.

6. The structure of claim 2, wherein a top side of said heat plate has a decorative board attached to it.

7. The structure of claim 6, wherein said decorative board is made of wood, brick or PVC material.

8. The structure of claim 2, wherein said heat conductor is a heat pipe.

9. The structure of claim 2, wherein said heat conductor is a heating wire.

10. The structure of claim 2, wherein said heat source is a hot-water jacket.

11. The structure of claim 2, wherein said heat source is a heating wire.

12. The structure of claim 2, wherein said heat source is connected to a temperature controller for controlling the temperature of said heat conductor so that heat dissipated by said heat conductor doesn't cause any harm to human skin.

13. The structure of claim 2, wherein said heat source is connected to a over-temperature control switch, whereby when the temperature of said heat conductor exceeds a predetermined threshold, said over-temperature control switch will cut off the connection of said heat conductor to said heat source to keep said temperature from rising and to protect human body.
